(19) United States
(12) Patent Application Publication
(10) Pub. No.: US 2016/0253338 A1
(43) Pub. Date: Sep. 1, 2016

(54) SYSTEM AND METHOD FOR DISPLAYING TIME IN A SINGLE-WORD UTC TIME STAMP

(71) Applicants: Michael J. Rieschl, Roseville, MN (US); Monica Mauer Langsford, Roseville, MN (US)

(72) Inventors: Michael J. Rieschl, Roseville, MN (US); Monica Mauer Langsford, Roseville, MN (US)

(73) Assignee: Unisys Corporation, Blue Bell, PA (US)

(21) Appl. No.: 14/632,299

(22) Filed: Feb. 26, 2015

(51) Int. Cl. G06F 17/30

(52) U.S. Cl. CPC G06F 17/30076; G06F 17/30091

(57) ABSTRACT

Systems and methods for displaying time in a single-word UTC time stamp are disclosed. Embodiments may include retrieving, from a memory, a single-word time stamp having a UTC time base and a multi-word configuration key associated with the single-word time stamp, wherein the single-word time stamp and the configuration key are associated with a data file. Embodiments may further include processing the configuration key to obtain a time zone offset value, a seasonal time offset value, a standard time mnemonic, and a seasonal time mnemonic associated with the single-word time stamp. Some embodiments may also include displaying time specified in the single-word time stamp as an fully qualified time based, at least in part, on the single-word time stamp and the obtained time zone offset value, seasonal time offset value, standard time mnemonic, and seasonal time mnemonic.

### FIELD OF THE DISCLOSURE

The instant disclosure relates generally to computer systems. More specifically, this disclosure relates to the implementation, processing, and displaying of single-word UTC time stamps in a computer system.

### BACKGROUND

Legacy mainframe systems, such as the Unisys ClearPath OS 2200, are widely known for providing high performance processing of critical data in high availability 24×7 systems. Because these systems have been in operation for many years and have volumes of application code designed for them, modifying the data structures in use by the applications is very difficult.

As an example, one data structure in use by a conventional legacy mainframe system is a time stamp data structure in which the time stamp value represents elapsed time since a predefined starting time. Because the time stamp value is stored in a storage structure, at some point in time the value of the time stamp will become too large for the storage structure containing it. In addition to limiting the maximum time value that can be stored in the data structure, the size of the storage structure also limits the information that can be stored by conventional time stamp data structures. For example, some conventional systems allocate the size of a word for storage of information in a time stamp. Because words are limited in size, conventional single-word time stamps are limited to storing, for example, only month, day, year, and seconds time data or, as another example, seconds since 1900. Therefore, display of conventional single-word time stamps is limited to display of only local time, and not UTC time, because user-friendly display of UTC time requires additional data, such as time zone offset, seasonal offset, standard time zone mnemonic, and seasonal time zone mnemonic data.

Some conventional systems have attempted to solve the foregoing issues by allocating a multi-word storage structure to a time stamp. However, such systems exhibit several drawbacks. For example, because multiple words worth of storage are allocated to a time stamp, each time a time stamp is created multiple words worth of memory and/or storage are consumed for the time stamp. As the number of time stamps created increases, the amount of memory and/or storage allocated to the time stamps could significantly reduce the amount of memory and/or storage available for use by the processor. In addition, modifying conventional systems to use multiple words for time stamps would require a significant overhaul of current time stamp data structures used by the systems, which, as mentioned above, is not a trivial task,

### SUMMARY

In some embodiments, implementation, processing, and displaying of time stamps in computer systems may be improved by using a single-word UTC time stamp and a multi-word key. According to one embodiment, a method for implementing a multi-word UTC time stamp using a single-word UTC time stamp and a multi-word key includes creating, by a processor, a data file. The method also includes creating, by the processor, a single-word time stamp to associate with the data file, wherein at least one bit of the single-word time stamp specifies a format of the single-word time stamp, at least one bit of the single-word time stamp indicates whether or not a seasonal offset is in effect, and a remainder of the bits of the single-word time stamp specify time in a UTC time base. The method further includes creating, by the processor, a multi-word configuration key to associate with the single-word time stamp, wherein the configuration key comprises a time zone offset value, a seasonal time offset value, a standard time mnemonic, and a seasonal time mnemonic. The method also includes storing, by the processor, in memory, the data file, single-word time stamp, and configuration key.

According to another embodiment, a computer program product may include a non-transitory computer-readable medium comprising instructions that, when executed by a processor of a computing system, cause the processor to perform the steps of creating a data file and creating a single-word time stamp to associate with the data file, wherein at least one bit of the single-word time stamp specifies a format of the single-word time stamp, at least one bit of the single-word time stamp indicates whether or not a seasonal offset is in effect, and a remainder of the bits of the single-word time stamp specify a time in a UTC time base. The medium also includes instructions that, when executed by a processor of a computing system, cause the processor to perform the step of creating a multi-word configuration key to associate with the single-word time stamp, wherein the configuration key comprises a time zone offset value, a seasonal time offset value, a standard time mnemonic, and a seasonal time mnemonic. The medium further includes instructions that, when executed by a processor of a computing system, cause the processor to perform the step of storing, in memory, the data file, single-word time stamp, and configuration key.

According to yet another embodiment, an apparatus may include a memory and a processor coupled to the memory. The processor may be configured to execute the steps of creating a data file and creating a single-word time stamp to associate with the data file, wherein at least one bit of the single-word time stamp specifies a format of the single-word time stamp, at least one bit of the single-word time stamp indicates whether or not a seasonal offset is in effect, and a remainder of the bits of the single-word time stamp specify a time in a UTC time base. The processor may also be configured to execute the step of creating a multi-word configuration key to associate with the single-word time stamp, wherein the configuration key comprises a time zone offset value, a seasonal time offset value, a standard time mnemonic, and a seasonal time mnemonic. The processor may be further configured to execute the step of storing, in memory, the data file, single-word time stamp, and configuration key,

According to one embodiment, a method for displaying time in a single-word UTC time stamp includes retrieving, by a processor, from a memory, a single-word time stamp having a UTC time base and a multi-word configuration key associated with the single-word time stamp, wherein the single-word time stamp and the configuration key are associated with a data file. The method also includes processing, by the processor, the configuration key to obtain a time zone offset value, a seasonal time offset value, a standard time mnemonic, and a seasonal time mnemonic associated with the single-word time stamp. The method further includes displaying, by the processor, time specified in the single-word time stamp as a fully qualified time based, at least in part, on the single-word time stamp and the obtained time zone offset value, seasonal time offset value, standard time mnemonic, and seasonal time mnemonic.

According to another embodiment, a computer program product may include a non-transitory computer-readable medium comprising instructions that, when executed by a processor of a computing system, cause the processor to perform the step of retrieving, from a memory, a single-word time stamp having a UTC time base and a multi-word configuration key associated with the single-word time stamp, wherein the single-word time stamp and the configuration key are associated with a data file. The medium also includes instructions that, when executed by a processor of a computing system, cause the processor to perform the step of processing the configuration key to obtain a time zone offset value, a seasonal time offset value, a standard time mnemonic, and a seasonal time mnemonic associated with the single-word time stamp. The medium also includes instructions that, when executed by a processor of a computing system, cause the processor to perform the step of displaying time specified in the single-word time stamp as a fully qualified time based, at least in part, on the single-word time stamp and the obtained time zone offset value, seasonal time offset value, standard time mnemonic, and seasonal time mnemonic.

According to yet another embodiment, an apparatus may include a memory and a processor coupled to the memory. The processor may be configured to execute the step of retrieving, from a memory, a single-word time stamp having a UTC time base and a multi-word configuration key associated with the single-word time stamp, wherein the single-word time stamp and the configuration key are associated with a data file. The processor may also be configured to execute the step of processing the configuration key to obtain a time zone offset value, a seasonal time offset value, a standard time mnemonic, and a seasonal time mnemonic associated with the single-word time stamp. The processor may be further configured to execute the step of displaying time specified in the single-word time stamp as fully qualified time based, at least in part, on the single-word time stamp and the obtained time zone offset value, seasonal time offset value, standard time mnemonic, and seasonal time mnemonic.

According to one embodiment, a method for distinguishing and processing multiple time stamp formats used in a single computing system includes retrieving, by a processor, a data file. The method also includes retrieving, by the processor, from a memory, a single-word time stamp associated with the data file, wherein the processor operates in an operating system environment in which multiple time stamp formats are available for creating time stamps. The method further includes determining, by the processor, a format of the retrieved single-word time stamp by processing at least one bit of the single-word time stamp. The method also includes selecting, by the processor, one of a limited time display format and fully qualified time display format for displaying time specified in the single-word time stamp based, at least in part, on the determined format of the single-word time stamp.

According to another embodiment, a computer program product may include a non-transitory computer-readable medium comprising instructions that, when executed by a processor of a computing system, cause the processor to perform the steps of retrieving a data file and retrieving, from a memory, a single-word time stamp associated with the data file, wherein the processor operates in an operating system environment in which multiple time stamp formats are available for creating time stamps. The medium also includes instructions that, when executed by a processor of a computing system, cause the processor to perform the step of determining a format of the retrieved single-word time stamp by processing at least one bit of the single-word time stamp. The medium further includes instructions that, when executed by a processor of a computing system, cause the processor to perform the step of selecting one of a limited time display format and fully qualified time display format for displaying time specified in the single-word time stamp based, at least in part., on the determined format of the single-word time stamp.

According to yet another embodiment, an apparatus may include a memory and a processor coupled to the memory. The processor may be configured to execute the steps of retrieving a data file and retrieving, from a memory, a single-word time stamp associated with the data tile, wherein the processor operates in an operating system environment in which multiple time stamp formats are available for creating time stamps. The processor may also be configured to execute the step of determining a format of the retrieved single-word time stamp by processing at least one bit of the single-word time stamp. The processor may be further configured to execute the step of selecting one of a limited time display format and fully qualified time display format for displaying time specified in the single-word time stamp based, at least in part, on the determined format of the single-word time stamp.

According to one embodiment, a method for obtaining time data displayable remotely from a single-word UTC time stamp includes retrieving, by a processor, a single-word UTC time stamp. The method also includes retrieving, by the processor, a multi-word configuration key associated with the single-word UTC time stamp, wherein the data in the configuration key comprises a time zone offset value, a seasonal time offset value, a standard time mnemonic, and a seasonal time mnemonic. The method further includes combining, by the processor, the time zone offset value, seasonal time offset value, standard time mnemonic, and seasonal time mnemonic from the multi-word configuration key with time data specified in the single-word UTC time stamp to obtain time data comprising time, time zone offset, seasonal time offset, standard time mnemonic, and seasonal time mnemonic.

According to another embodiment, a computer program product may include a non-transitory computer-readable medium comprising instructions that, when executed by a processor of a computing system, cause the processor to perform the step of retrieving a single-word UTC time stamp. The medium also includes instructions that, when executed by a processor of a computing system, cause the processor to perform the step of retrieving a multi-word configuration key associated with the single-word UTC time stamp, wherein the data in the configuration key comprises a time zone offset value, a seasonal time offset value, a standard time mnemonic, and a seasonal time mnemonic. The medium further includes instructions that, when executed by a processor of a computing system, cause the processor to perform the step of combining the time zone offset value, seasonal time offset value, standard time mnemonic, and seasonal time mnemonic from the multi-word configuration key with time data specified in the single-word UTC time stamp to obtain time data comprising time, time zone offset, seasonal time offset, standard time mnemonic, and seasonal time mnemonic.

According to yet another embodiment, an apparatus may include a memory and a processor coupled to the memory. The processor may be configured to execute the steps of retrieving a single-word UTC time stamp and retrieving a multi-word configuration key associated with the single-word UTC time stamp, wherein the data in the configuration key comprises a time zone offset value, a seasonal time offset value, a standard time mnemonic, and a seasonal time mnemonic. The processor may also be configured to execute the step of combining the time zone offset value, seasonal time offset value, standard time mnemonic, and seasonal time mnemonic from the multi-word configuration key with time data specified in the single-word UTC time stamp to obtain time data comprising time, time zone offset, seasonal time offset, standard time mnemonic, and seasonal time mnemonic.

According to one embodiment, a method for converting a format of a time stamp may include retrieving, by the processor, from a memory, a single-word time stamp. The method may also include identifying, by the processor, a first format of the retrieved single-word time stamp by processing at least one bit of the single-word time stamp. The method may further include converting, by the processor, the format of the retrieved single-word time stamp from the first format to a second format using a multi-word configuration key associated with the single-word time stamp.

According to another embodiment, a computer program product may include a non-transitory computer-readable medium comprising instructions that, when executed by a processor of a computing system, cause the processor to perform the step of retrieving, from a memory, a single-word time stamp. The medium also includes instructions that, when executed by a processor of a computing system, cause the processor to perform the step of identifying a first format of the retrieved single-word time stamp by processing at least one bit of the single-word time stamp. The medium further includes instructions that, when executed by a processor of a computing system, cause the processor to perform the step of converting the format of the retrieved single-word time stamp from the first format to a second format using a multi-word configuration key associated with the single-word time stamp.

According to yet another embodiment, an apparatus may include a memory and a processor coupled to the memory. The processor may be configured to execute the step of retrieving, from a memory, a single-word time stamp. The processor may also be configured to execute the step of identifying a first format of the retrieved single-word time stamp by processing at least one bit of the single-word time stamp. The processor may be further configured to execute the step of converting the format of the retrieved single-word time stamp from the first format to a second format using a multi-word configuration key associated with the single-word time stamp.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the concepts and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed systems and methods, reference is now made to the following descriptions taken in conjunction with the accompanying drawings.

FIG. 1 is a flow chart illustrating a method for implementing a multi-word coordinated universal time (UTC) time stamp using a single-word UTC time stamp and a multi-word key according to one embodiment of the disclosure.

FIG. 2 is a diagram illustrating a single-word UTC time stamp format according to one embodiment of the disclosure.

FIG. 3 is a diagram illustrating a multi-word configuration key according to one embodiment of the disclosure.

FIG. 4 is a diagram illustrating that information in a single-word UTC time stamp and in a multi-word configuration key may be combined to provide at least the same information available in a multi-word time stamp according to one embodiment of the disclosure.

FIG. 5 is a flow chart illustrating a method for distinguishing and processing multiple time stamp formats used in a single computing system according to one embodiment of the disclosure.

FIGS. 6A-6C are diagrams illustrating different time stamp formats according to embodiments of the disclosure.

FIGS. 7A and 7B are flow charts illustrating a method for displaying time in a single-word UTC time stamp according to one embodiment of the disclosure.

FIG. 8 is a flow chart illustrating a method for obtaining time data displayable remotely from a single-word UTC time stamp according to one embodiment of the disclosure.

FIG. 9 is a flow chart illustrating a method for converting a format of a time stamp according to one embodiment of the disclosure.

FIG. 10 is a block diagram illustrating a computer network according to one embodiment of the disclosure.

FIG. 11 is a block diagram illustrating a computer system according to one embodiment of the disclosure,

FIG. 12A is a block diagram illustrating a server hosting an emulated software environment for virtualization according to one embodiment of the disclosure.

FIG. 12B is a block diagram illustrating a server hosting an emulated hardware environment according to one embodiment of the disclosure.

### DETAILED DESCRIPTION

In some embodiments, implementation, processing, and displaying of time stamps in computer systems may be improved by using a single-word UTC time stamp and a multi-word key. For example, to aid in remote display of time data in the single-word time stamp, the single-word time stamp can be configured to include additional information, such as data that indicates whether or not a seasonal offset is in effect in the geographical area in which the time stamp was created. In some embodiments, the single-word time stamp can be associated with a multi-word configuration key that includes a time zone offset value, a seasonal time offset value, a standard time mnemonic, and a seasonal time mnemonic. By processing the single-word time stamp in collaboration with the multi-word configuration key associated with the time stamp, the time data in the time stamp can be displayed locally and/or remotely because all the data needed for remote display may be contained within the single-word UTC time stamp and the multi-word configuration key.

To reduce memory consumption, the multi-word configuration key may be associated with multiple single-word time stamps so that only one single-word time stamp may be created each time a new time stamp is needed for a data file. Multiple single-word time stamps created in the same time zone and season can then be associated with a single multi-word configuration key created for that time zone and season. In some embodiments, by associating a multi-word configuration key with multiple single-word time stamps, a multi-word configuration key may not need to be created each time a new time stamp is needed for a data file, thus reducing memory consumption.

In some embodiments, by implementing the new time stamps as single-word time stamps, disruption associated with using a new time stamp format may be reduced. For example, in computer systems originally designed to use single-word time stamp data structures, implementing the single-word UTC time stamps of this disclosure may not require modifications to the existing time stamp data structures and the application code that uses the existing time stamp data structures. Instead, the new single-word UTC time stamp format may be used as an alternative to the original time stamp format used by the computer system. In some embodiments, having multiple time stamp formats available for time stamping may improve time stamp implementation of the computer system because the computer system may choose between using the new single-word UTC time stamp format or the original time stamp format when creating new time stamps for data tiles. In some embodiments, to aid in the processing of the multiple time stamp formats, the new single-word UTC time stamp may include an identifier that specifies the format of the new single-word time stamp and that allows the computer system to distinguish the new single-word time stamp format from the original or default time stamp format.

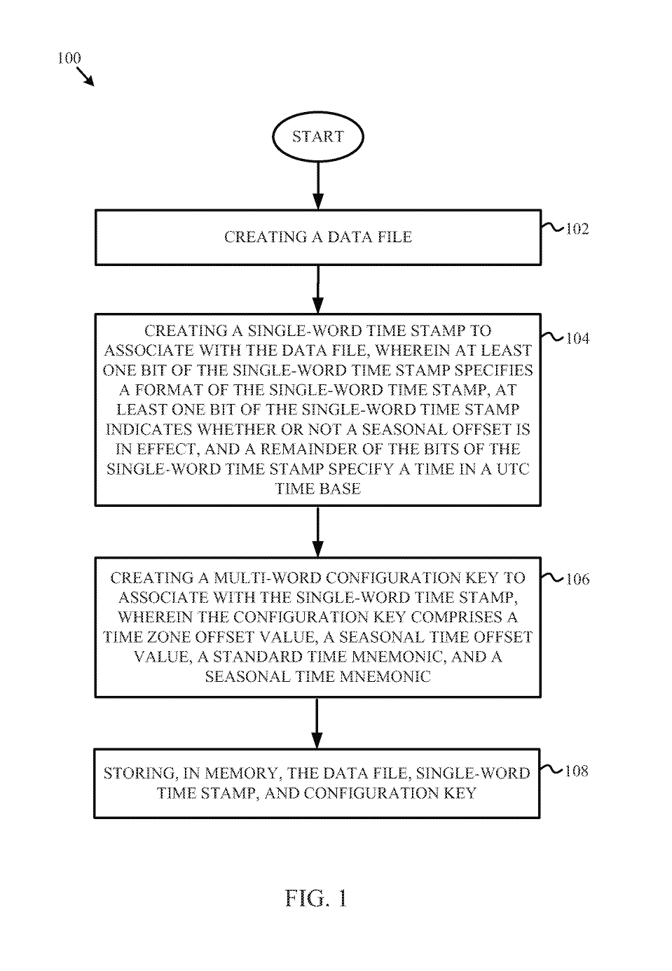

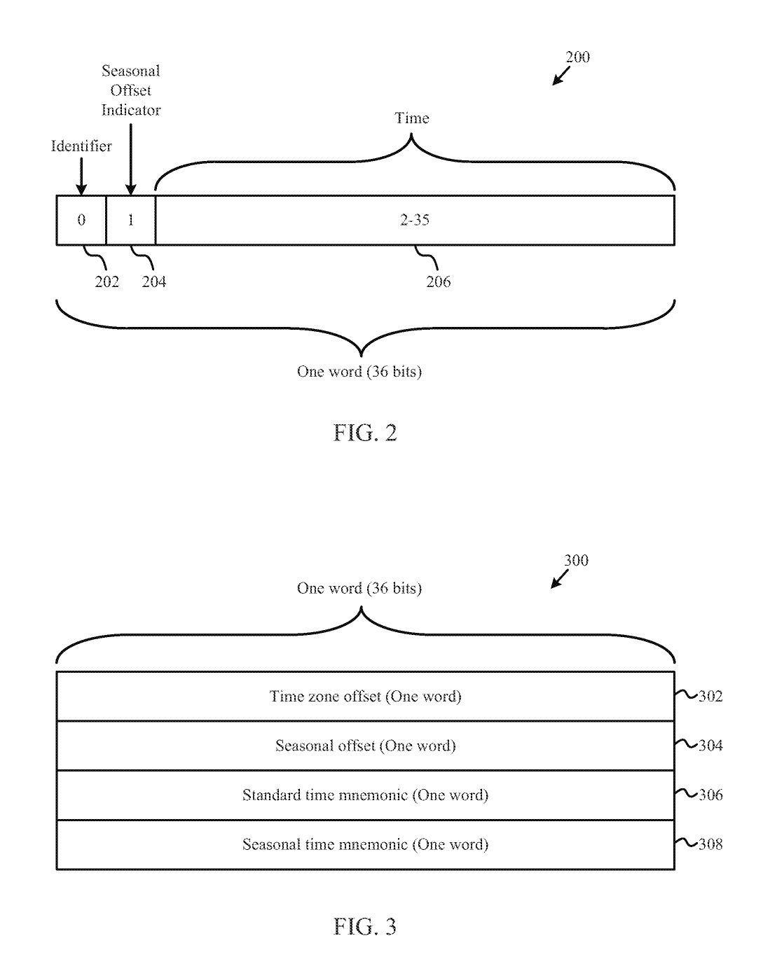

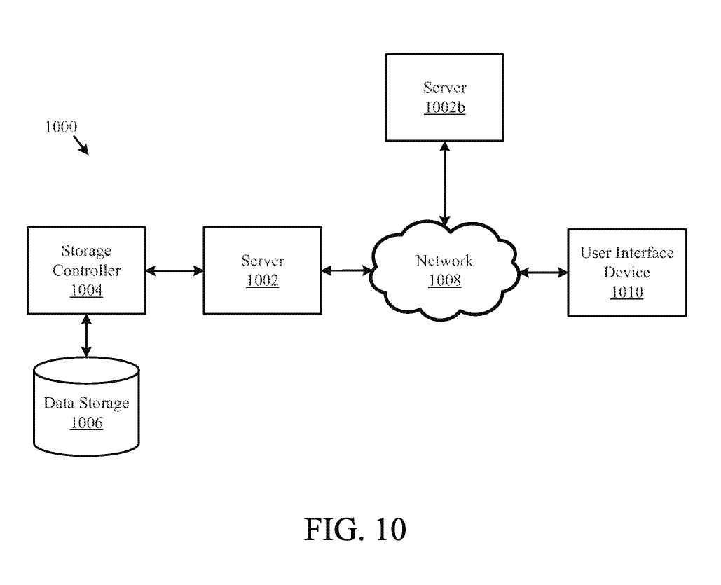

FIG. 1 is a flow chart illustrating a method for implementing a multi-word UTC time stamp using a single-word UTC time stamp and a multi-word key according to one embodiment of the disclosure. It is noted that embodiments of method 100 may be implemented with the systems described with respect to FIGS. 10-12. Specifically, a method 100 includes, at block 102, creating, by a processor, a data file. In some embodiments, data files may include dump files, log files, audit trail files, program files, and the like. At block 104, method 100 may include creating, by the processor, a single-word time stamp to associate with the data file, wherein at least one bit of the single-word time stamp specifies a format of the single-word time stamp, at least one bit of the single-word time stamp indicates whether or not a seasonal offset is in effect, and a remainder of the bits of the single-word time stamp specify a time in a UTC time base. As an example, FIG. 2 is a diagram illustrating a single-word UTC time stamp format according to one embodiment of the disclosure. The single-word UTC time stamp format 200 includes an identifier 202, a seasonal offset indicator 204, and time 206. In the embodiment of FIG. 2, the single-word UTC time stamp 200 is 36 bits wide. In some embodiments, the 36 bits may correspond to the bit-width of a word processed by a computing system.

According to the embodiment of FIG. 2, a single bit, such as bit 0 of the single-word time stamp 200, may be reserved for the identifier 202. In addition, a single bit, such as bit I of the single-word time stamp 200, may be reserved for the seasonal offset indicator 204. The remainder of the bits in the word, such as bits 2-35 of the single-word time stamp 200, may be reserved for the time 206. In some embodiments, setting the seasonal offset indicator 204 to a value of “0” may indicate that no seasonal offset is in effect at the UTC time specified by the time 206. In contrast, setting the seasonal offset indicator 204 to a value of “1” may indicate that a seasonal offset is in effect at the UTC time specified by the time 206. In other embodiments, setting the seasonal offset indicator 204 to a value of “1” may indicate that no seasonal offset is in effect at the UTC time specified by the time 206, and setting the seasonal offset indicator 204 to a value of “0” may indicate that a seasonal offset is in effect at the UTC time specified by the time 206.

In some embodiments, the time 206 specified in the single-word UTC time stamp 200 may be linear time specifying a number in seconds since 00:00:00 1899, December 31 in a UTC time base. In some embodiments, the time 206 specified in the single-word UTC time stamp 200 may be linear time specifying a number of seconds since a base value other than 00:00:00 1899, December 31. In addition, in some embodiments the time 206 specified in the single-word UTC time stamp 200 may have a granularity of seconds. In some embodiments, the granularity may be different than seconds, such as, for example, nanoseconds, milliseconds, hours, days, month, etc.

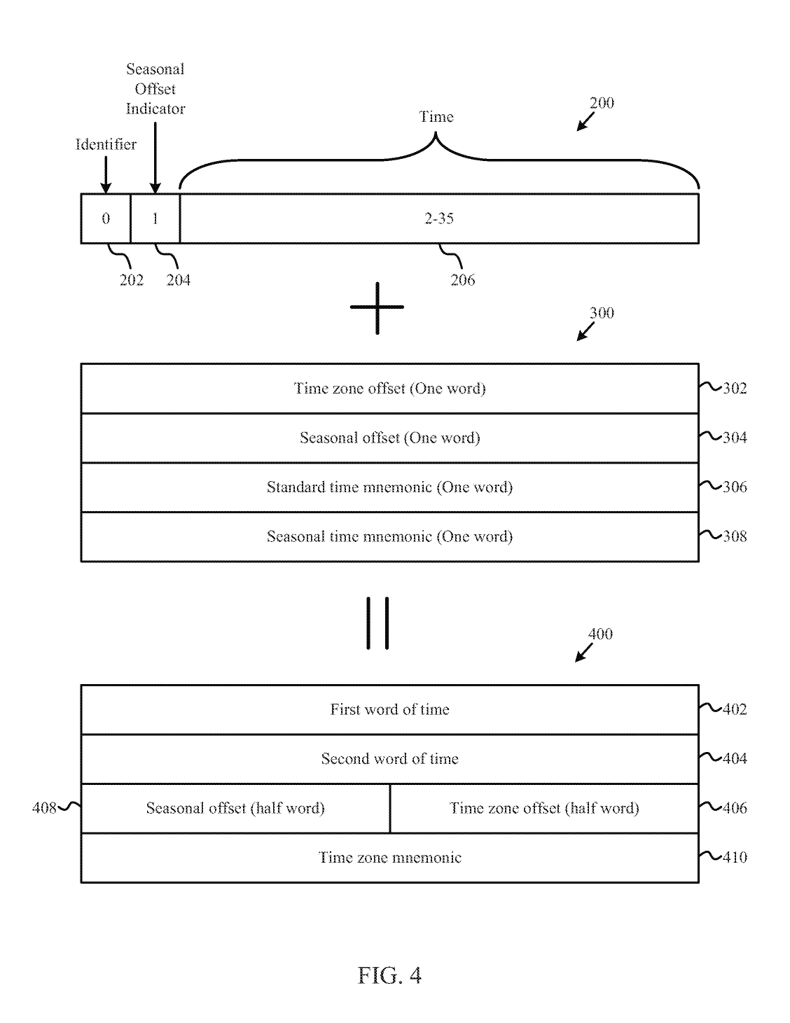

Returning to FIG. 1, method 100 includes, at block 106, creating, by the processor, a multi-word configuration key to associate with the single-word time stamp, wherein the configuration key comprises a time zone offset value, a seasonal time offset value, a standard time mnemonic, and a seasonal time mnemonic. As an example, FIG. 3 is a diagram illustrating a multi-word configuration key according to one embodiment of the disclosure. The multi-word configuration key 300 includes four words. For example, the multi-word configuration key 300 includes one word dedicated to the time zone offset 302, one word dedicated to the seasonal offset 304, one word dedicated to the standard time mnemonic 306, and one word dedicated to the seasonal time mnemonic 308. In some embodiments, the size of a word illustrated in FIG. 3 may be 36 bits. In general, the size of a word described in FIG. 3, and throughout this disclosure, may correspond to whatever the bit-width is of words processed by a computing system that creates the multi-word configuration key. For example, in one embodiment, a word may correspond to 36 bits, while in another embodiment a word may correspond to 72 bits, while in yet another embodiment a word may correspond to 64 bits.

According to the embodiment of FIG. 3, the time zone offset 302 may specify the time zone offset for the local time zone, i.e., the difference between the local time and the UTC time, for example, in seconds. The time zone offset value 302 may be positive or negative. The seasonal offset 304 may specify the amount of time, such as minutes, to be added to local time by a computer system when the seasonal offset indicator of the single-word UTC time stamp, such as seasonal offset indicator 204, indicates that a seasonal offset is in effect. In some embodiments, the seasonal offset may represent an offset in addition to the time zone offset.

In some embodiments, the standard time mnemonic 306 may specify the standard time zone mnemonic as one or more characters. For example, in one embodiment, four ASCII characters may be stored in the standard time mnemonic 306 word of the configuration key 300 to represent the standard time mnemonic. Similarly, in some embodiments, the seasonal time mnemonic 308 may specify the seasonal time zone offset as one or more characters. For example, in one embodiment, four ASCII characters may be stored in the seasonal time mnemonic 308 word of the configuration key 300 to represent the seasonal time mnemonic.

Returning to FIG. 1, method 100 includes, at Hock 108, storing, by the processor, in memory, the data file, single-word time stamp, and configuration key. For example, in one embodiment, the single-word UTC time stamp, such as single-word UTC time stamp 200, and the configuration key, such as multi-word configuration key 300, may be embedded in the data file so that when the data file is stored in memory, the embedded single-word UTC time stamp and multi-word configuration key also get stored in memory. In another embodiment, the configuration key may be stored in memory separately by the computer system. For example, the computer system may store the configuration key in memory upon being booted or being rebooted.

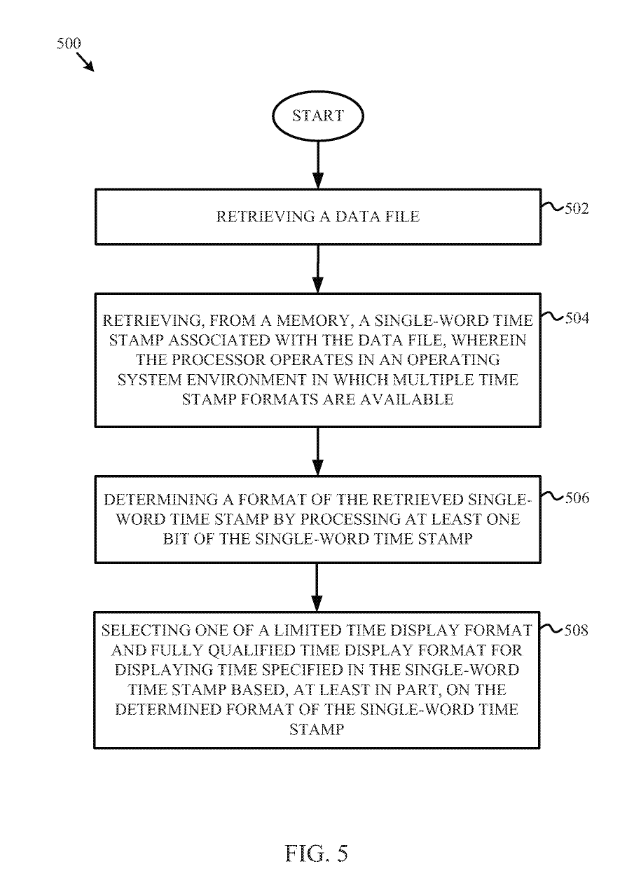

In some embodiments, the information in the single-word UTC time stamp can be combined with the information in the multi-word configuration key to display time specified in the single-word UTC time stamp locally or remotely. In other words, the information in the single-word UTC time stamp and the information in the multi-word configuration key can be combined to provide at least the information typically included in large multi-word time stamp formats used to display time in the multi-word time stamps locally or remotely. For example, FIG. 4 is a diagram illustrating that information in a single-word UTC time stamp and in a multi-word configuration key may be combined to provide at least the same information available in a multi-word time stamp according to one embodiment of the disclosure. In particular, FIG. 4 illustrates, in addition to the single-word UTC time stamp 200 illustrated. In FIG. 2 and the multi-word configuration key 300 illustrated in FIG. 3, a multi-word time stamp 400.

In some embodiments, the multi-word time stamp 400 may be a time stamp format based on an industry standard time format. According to the embodiment of FIG. 4, the multi-word time stamp 400 may be a 4-word structure that contains unambiguous and always increasing time. For example, in embodiments in which a word is 36 bits, the multi-word time stamp 400 may correspond to 144 bits. In some embodiments, time in the multi-word time stamp 400 may be binary linear UTC time specified in nanoseconds since 00:00:00, Dec. 31, 1899. Time may he stored in two words of the multi-word time stamp 400. For example, word 402 may be used to store one portion of the time data and word 404 may be used to store the remainder of the time data. Half word 406 may be used to store the time zone offset for the local time zone, such as the difference in time between the local time and the UTC time. According to one embodiment, the time zone offset can be positive or negative. Half word 408 may be used to store the seasonal shift offset in effect at the time, such as a one-hour increase in the time for Daylight Saving Time. The time zone mnemonic word 410 may specify the standard time zone as one or more characters. For example, in one embodiment, four ASCII characters may be stored in the time zone mnemonic 410 word of the multi-word time stamp 400 to represent the time zone mnemonic. In some embodiments, all the information in the multi-word time stamp 400 may be sufficient information to display the time locally or remotely. In some embodiments, displaying time either locally or remotely may be based on processing of the multi-word time stamp 400.

As noted above, the information in the single-word UTC time stamp 200 and the information in the multi-word configuration key 300 can be combined to provide at least the information typically included in large multi-word time stamp formats, such as multi-word time stamp 400, used to display time in the multi-word time stamps locally or remotely. In particular, in some embodiments, a computer system may retrieve the single-word time stamp and configuration key from memory and then create a multi-word time stamp having a different format than the single-word time stamp, such as a multi-word format, based, at least in part, on processing of the retrieved single-word time stamp and the configuration key. For example, the time 206 of the single-word time stamp 200 may correspond to the time stored in the first two words 402-404 of multi-word time stamp 400. The time zone offset half word 406 may correspond to the time zone offset word 302 of the configuration key 300. The seasonal offset half word 408 may correspond to the seasonal offset indicator 204 of the single-word UTC time stamp 200 and the seasonal offset 304 of the configuration key 300. In addition, the time zone mnemonic word 410 of the multi-word time stamp 400 may correspond to the standard time mnemonic word 306 of the configuration key 300.

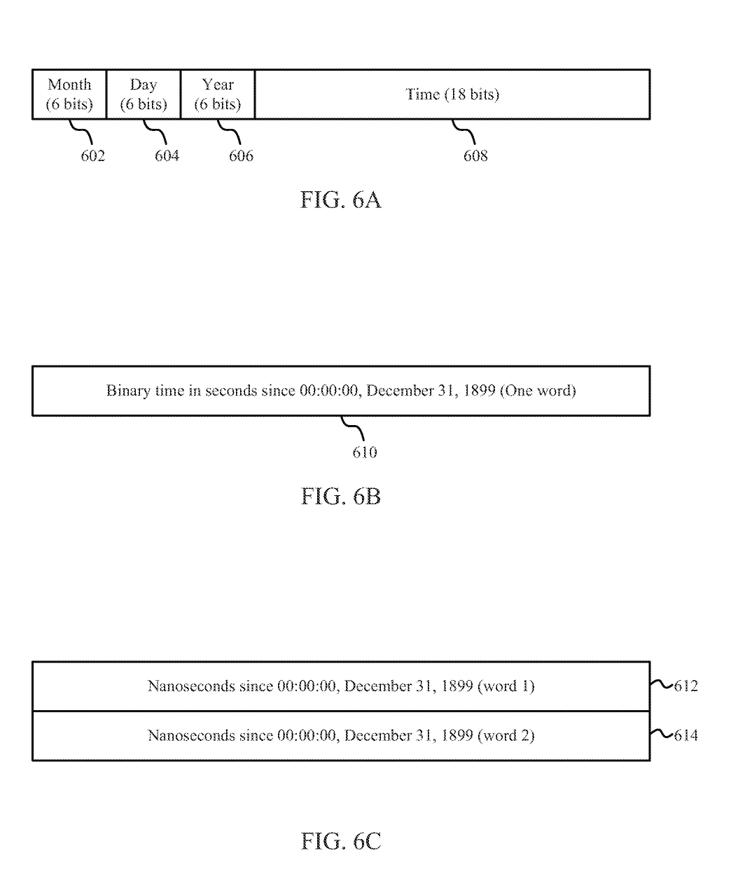

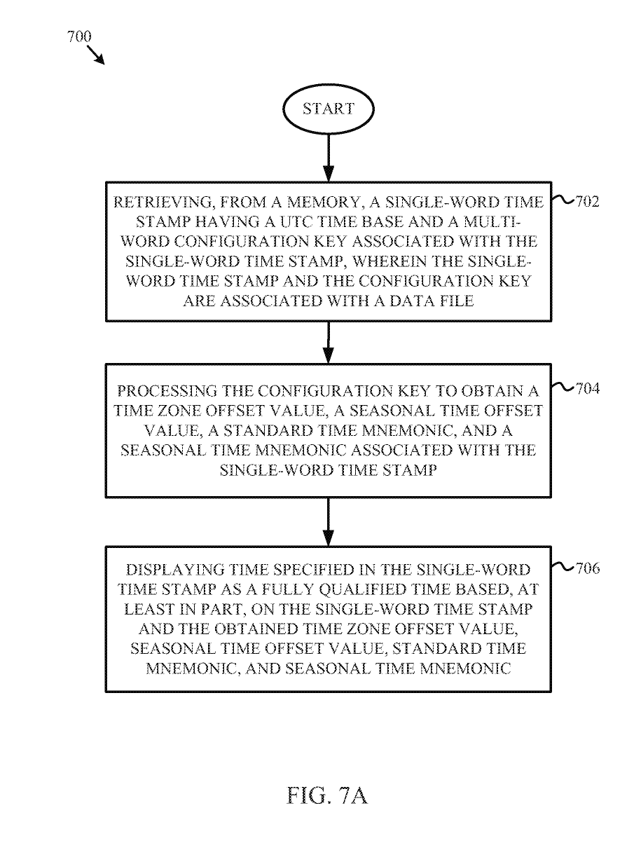

FIG. 5 is a flow chart illustrating a method for distinguishing and processing multiple time stamp formats used in a single computing system according to one embodiment of the disclosure. It is noted that embodiments of method 500 may be implemented with the systems described with respect to FIGS. 10-12. Specifically, a method 500 includes, at block 502, retrieving, by a processor, a data file, At block 504, method 500 includes retrieving, by the processor, from a memory, a single-word time stamp associated with the data file, wherein the processor operates in an operating system environment in which multiple time stamp formats are available for creating time stamps. For example, in one embodiment, a processor within a computing system may be configured to choose between the single-word UTC time stamp format illustrated in FIG. 2 or one of the time stamp formats illustrated in FIGS. 6A-6C when creating a time stamp to associate with a data file,

FIG. 6A is a diagram illustrating a time stamp format according to one embodiment of the disclosure. In some embodiments, the time stamp format illustrated in FIG. 6A may be a single-word binary time stamp format with time specified in a local time base. The time stamp format of FIG. 6A includes a first number of bits 602 to specify a month, a second number of bits 604 to specify a day, a third number of bits 606 to specify a year, and a fourth number of bits 608 to specify a time, such as a number of seconds past midnight. In some embodiments, the word size for the time stamp format illustrated in FIG. 6A may be 36 bits. In addition, according to one embodiment, the first number of bits 602 may be 6 bits, the second number of bits 604 may be 6 bits, the third number of bits 606 may be 6 bits, and the fourth number of bits 608 may be 18 bits.

FIG. 6B is a diagram illustrating another time stamp format according to one embodiment of the disclosure. In some embodiments, the time stamp format illustrated in FIG. 6B may be a single-word binary time stamp format with time specified in either a UTC time base or a local time base. The time stamp format illustrated in FIG. 6B represents time as binary time in seconds since a universally agreed to start point, such as 00:00:00, Dec. 31, 1899. According to one embodiment, the word size for the time stamp format illustrated in FIG. 6B may be36 bits.

FIG. 6C is a diagram illustrating another time stamp format according to one embodiment of the disclosure. In some embodiments, the time stamp format illustrated in FIG. 6C may be a two-word binary time stamp format with time specified in either a UTC time base or a local time base. According to one embodiment, the two-word size of the time stamp format illustrated in FIG. 6C may correspond to 72 bits. In some embodiments, the time stamp format of FIG. 6C may allow for greater time granularity. For example, in one embodiment, whereas the time stamp format illustrated in FIG. 6B represents time as binary time in seconds since a universally agreed to start point, such as 00:00:00, Dec. 31, 1899, the time stamp format illustrated in FIG. 6C may represent time as binary time in nanoseconds since 00:00:00, Dec. 31, 1899. A first portion of the time in nanoseconds may be stored in the first word 612 while a second portion of the time in nanoseconds may be stored in the second word 614.

In some embodiments, one or more of the time stamp formats illustrated in FIGS. 6A-6C may be included as part of the multiple time stamp formats available for creating time stamps by a computer system. In addition, according to one embodiment, one or more of the time stamp formats illustrated in FIGS. 6A-6C may be default or original time stamp formats used by the computer system to create time stamps for data files.

Returning to FIG. 5, method 500 includes, at block 506, determining, by the processor, a format of the retrieved single-word time stamp by processing at least one bit of the single-word time stamp. To illustrate determining a format of the retrieved single-word time stamp by processing at least one bit of the single-word time stamp, such as at block 506, consider an embodiment in which a processor within a computing system operates in an environment in which it may choose between the single-word UTC time stamp format illustrated in FIG. 2 or the time stamp format illustrated in FIG. 6A as the format to use for a time stamp that needs to be created for a data file. In some embodiments, retrieving a single-word time stamp associated with the data file may correspond to the receipt of a single-word UTC time stamp 200 illustrated in FIG. 2, whereas, in other embodiments, retrieving a single-word time stamp associated with the data file may correspond to the receipt of the time stamp illustrated in FIG. 6A. As was noted with reference to FIG. 2, a single-word UTC time stamp format 200 includes an identifier 202 to specify the format of the time stamp. Therefore, when a single-word UTC time stamp 200 is received, determining the format of the retrieved single-word time stamp by processing at least one bit of the single-word time stamp, such as at block 506, may include processing an identifier bit, such as identifier bit 202. Although the time stamp format illustrated in FIG. 6A does not include an identifier bit, the format can still be distinguished from the single-word UTC time stamp 200 by processing the left-most bit of the time stamp, also known as the most significant bit (MSB).

For example, as shown in FIG. 6A, the 6 MSBs may be allocated to specify the month in a time stamp formatted according to FIG. 6A, However, because there are only twelve months only 4 binary bits may be needed to specify a month. Therefore, in some embodiments, when the time stamp format illustrated in FIG. 6A is used, the MSB will have a value of “0.” By setting the identifier bit 202 of a single-word UTC time stamp 200 formatted as shown in FIG. 2 to “1” when the single-word UTC time stamp is created, time stamps formatted according to the time stamp format in FIG. 6A may be distinguished from time stamps formatted according to the time stamp format in FIG. 2. For example, when a time stamp is retrieved, such as at block 504, if the MSB is “1,” then the processor of the computing system may determine that the format of the time stamp corresponds to the format of a single-word UTC time stamp illustrated in FIG. 2 because the MSB of a created time stamp is always set to “1” when the created time stamp has the format of a single-word UTC time stamp illustrated in FIG. 2 and the MSB of a time stamp formatted according to the time stamp format illustrated in FIG. 6A cannot be set to “1.” Likewise, when a time stamp is retrieved, such as at block 504, if the MSB is “0,” then the processor of the computing system may determine that the format of the time stamp corresponds to the format of a time stamp illustrated in FIG. 6A because the MSB of a created time stamp is always set to “0” when the created time stamp has the format of a time stamp illustrated in FIG. 6A and the MSB of a time stamp formatted according to the single-word UTC time stamp format illustrated in FIG. 2 is set to “1.”

As the foregoing has shown, a time stamp formatted according to the time stamp format illustrated in FIG. 2 may be distinguished from a time stamp formatted according to the time stamp format illustrated in FIG. 6A by processing the MSB of the time stamp. Therefore, in embodiments in which the time stamp format illustrated in FIG. 6A is the original or default time stamp used by the computer system, the time stamp format illustrated in FIG. 2 can be used to replace the original/default time stamp format without modifying the data storage structures used for time stamps because, in addition to being distinguishable from each other, time stamps formatted according to the format illustrated in FIG. 6A and time stamps formatted according to the format illustrated in FIG. 2 are both allocated a single word data storage structure. For the same reasons, in other embodiments, rather than replacing the original/default time stamp format, such as the time stamp format illustrated in FIG. 6A, the time stamp format illustrated in FIG. 2 may he used as an alternate time stamp format so that the computer system may choose between the time stamp format illustrated in FIG. 2 or the time stamp format illustrated in FIG. 6 when creating a time stamp for a data file.

Although the foregoing example is detailed with the time stamp format illustrated in FIG. 6A as the original or default time stamp format, one of skill in the art will readily recognize that, in some embodiments, other time stamp formats may serve as the original or default time stamp formats without departing from this disclosure in spirit or scope. For example, in some embodiments, one or more of the time stamp formats illustrated in FIGS. 6A-6C may serve as the original or default time stamp formats used in the computer system. In general, according to some embodiments, a processor configured according to embodiments of this disclosure may operate in an OS environment in which the default time stamp format is different than the format of the single-word OTC time stamp illustrated in FIG. 2.

Returning to FIG. 5, method 500 includes, at block 508, selecting, by the processor, one of a limited time display format and fully qualified time display format for displaying time specified in the single-word time stamp based, at least in part, on the determined format of the single-word time stamp. According to some embodiments, the time specified in the single-word time stamp may be displayed as one of limited time and fully qualified time based, at least in part, on the selected display format, which may correspond to the UTC single-word format 204. For example, in embodiments in which the time stamp format illustrated in FIG. 6A is the original or default time stamp format used by the computer system, when a retrieved time stamp is determined, such as at block 506, to be a time stamp formatted according to the time stamp format illustrated in FIG. 6A, the processor of the computer system may select, such as at block 508, the limited time display format because time data in a time stamp formatted according to the time stamp format illustrated in FIG. 6A can be displayed only as limited time display. Accordingly, time specified in the retrieved single-word time stamp, such as at block 504, may be displayed as a limited time display when the retrieved time stamp is formatted according to the time stamp format illustrated in FIG. 6A.

As noted above, in some embodiments, a limited time display may correspond to a display of time that does not include one or more of a time zone offset, seasonal offset, standard time zone mnemonic, and seasonal time zone mnemonic data. In contrast, in some embodiments, a qualified time display may correspond to a display of time that includes one or more of a time zone offset, seasonal offset, standard time zone mnemonic, and seasonal time zone mnemonic data.

When the retrieved time stamp is determined, such as at block 506, to be a time stamp formatted according to the time stamp format illustrated in FIG. 2, the processor of the computer system may select, such as at block 508, the limited time display format or the fully qualified time display format because time data in a time stamp formatted according to the time stamp format illustrated in FIG. 2 can be displayed as a limited time display or as fully qualified time. For example, in some embodiments, a single-word time stamp formatted according to the time stamp format illustrated in FIG. 2 may contain sufficient information to display the time data in the time stamp as a UTC-based limited time display. More information may be necessary in sonic embodiments to display the time remotely as fully qualified time. However, as previously disclosed, in some embodiments by processing a single-word UTC time stamp formatted according to the time stamp format illustrated in FIG. 2 in collaboration with a multi-word configuration key associated with the time stamp, such as a multi-word configuration key 300, the time data in the time stamp can be displayed as fully qualified time in the time of the local system by using the key produced by the local system, or as fully qualified time in the time of the remote system using the key produced by the remote system, because all the data needed for remote display of the time as fully qualified time may be contained within the single-word UTC time stamp and the multi-word configuration key. Therefore, in some embodiments, a multi-word configuration key, such as multi-word configuration key 300, associated with the retrieved single-word UTC time stamp, such as single-word UTC time stamp 200, may be retrieved based, at least in part, on the selected display format, which may be the single-word UTC time stamp format 204. In other words, when the computer system processor determines, such as at block 506, that the time stamp format of the retrieved, such as at block 504, is the time stamp format illustrated in FIG. 2, and the computer system processor selects, such as at block 508, to display the time data in the time stamp as fully qualified time, then the computer system processor may retrieve a multi-word configuration key associated with the retrieved single-word UTC time stamp. The single-word time stamp may then be processed in collaboration with the multi-word configuration key to display the time data in the time stamp. In other words, the time may be displayed based, at least in part, on processing of the single-word time stamp and the configuration key.

Although the foregoing discussion refers specifically to time stamps formatted according to the time stamp formats illustrated in FIG. 2 and FIG. 6A, one of skill in the art will readily recognize that, in some embodiments, other time stamp formats may be interchanged with the time stamp formats specifically referred to in the discussion without departing from this disclosure in spirit or scope. For example, in some embodiments, either of the time stamp formats illustrated in FIGS. 6B-6C may serve as the time stamp retrieved at block 504.

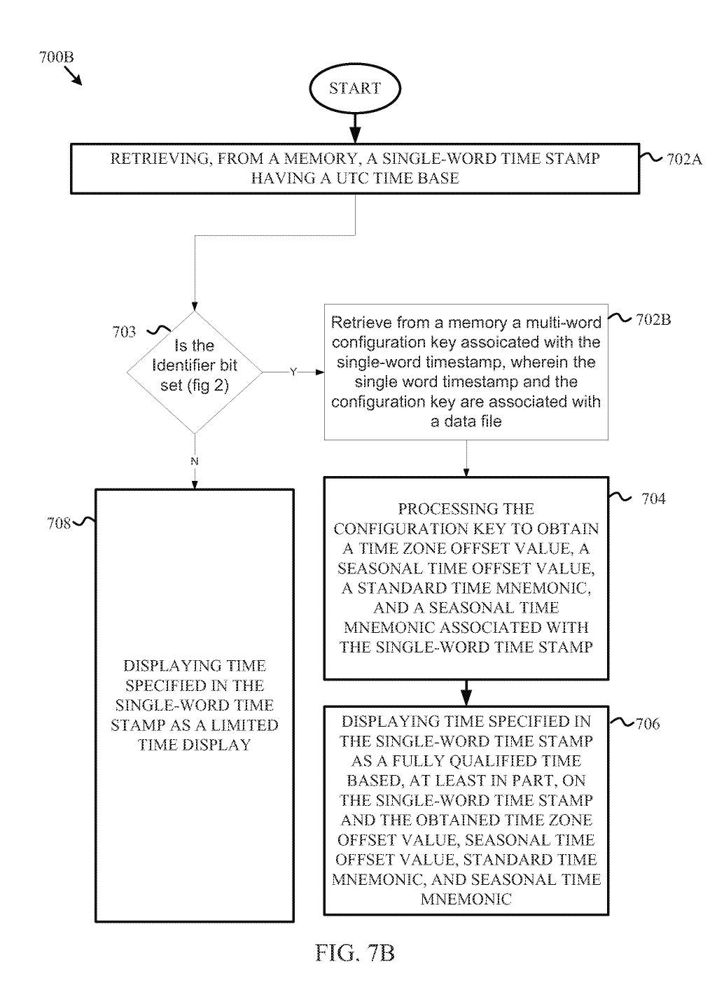

FIG. 7A is a flow chart illustrating a method for displaying time in a single-word UTC time stamp according to one embodiment of the disclosure. It is noted that embodiments of method 700 may be implemented with the systems described with respect to FIGS. 10-12. Specifically, method 700 includes at block 702 retrieving, by a processor, from a memory, a single-word time stamp having a UTC time base and a multi-word configuration key associated with the single-word time stamp, wherein the single-word time stamp and the configuration key are associated with a data file. According to one embodiment, the memory from which the single-word time stamp and the configuration key are retrieved may be located remotely from the computer system that is retrieving the single-word time stamp and multi-word configuration key at block 702. In another embodiment, the memory may be located locally, or in other words, physically coupled to the computer system retrieving the single-word time stamp and multi-word configuration key at block 702.

In some embodiments, the computing system may make an executive request (ER) or CALL to an interface to retrieve the current time in a desired time stamp, such as a time stamp formatted according to one of the time stamp formats illustrated in FIG. 2 or FIGS. 6A-6C. According to one embodiment, an ER “MODSWTIME$” may be made by the computer system to retrieve, from an ER interface, a single-word UTC time stamp, such as single-word UTC time stamp 200 illustrated in FIG. 2, with the current time formatted according to the time stamp format illustrated in FIG. 2. According to another embodiment, a CALL “MOD$SWTIME” may be made by the computer system to retrieve, from the CALL interface, a single-word UTC time stamp, such as single-word UTC time stamp 200 illustrated in FIG. 2, with the current time formatted according to the time stamp format illustrated in FIG. 2. Because in both situations, the retrieved time stamp is a single-word UTC time stamp, the leftmost bit (MSB) may be set to “1” to indicate that the time stamp is formatted according to the time stamp format illustrated in FIG. 2.

In some embodiments, the computing system may make an ER or CALL to an interface to retrieve the multi-word configuration key, such as multi-word configuration key 300, associated with the retrieved single-word time stamp. According to one embodiment, an ER “TIMECONFIGS” may be made by the computer system to retrieve time configuration information stored in the time configuration key, such as a time zone offset value, a seasonal time offset value, a standard time mnemonic, and a seasonal time mnemonic. According to another embodiment, a CALL “TIME$CONFIG” may be made by the computer system to retrieve, from the CALL interface, a multi-word time configuration key, such as multi-word configuration key 300.

Returning to FIG. 7A, method 700 includes, at block 704, processing, by the processor, the configuration key to obtain a time zone offset value, a seasonal time offset value, a standard time mnemonic, and a seasonal time mnemonic associated with the single-word time stamp. At block 706, method 700 includes displaying, by the processor, time specified in the single-word time stamp as a fully qualified time based, at least in part, on the single-word time stamp and the obtained time zone offset value, seasonal time offset value, standard time mnemonic, and seasonal time mnemonic.

In some embodiments, at least one bit of the single-word UTC time stamp that specifies a format of the single-word time stamp, such as the leftmost bit (MSB) of the retrieved single-word time stamp, may be processed, such as at block 506 of method 500, to determine a format of the single-word time stamp. As was disclosed previously with reference to block 508 of method 500, based on the determined format of the single-word time stamp, the time data in the single-word time stamp may be displayed as a fully qualified time after retrieving and processing a multi-word time configuration key associated with the single-word time stamp.

In some embodiments, the time data specified in the single-word time stamp may also be displayed as a limited time display. For example, as disclosed previously, a single-word UTC time stamp, such as single-word UTC time stamp 200 may include sufficient information to display the time data in the time stamp as a limited time display. Therefore, in some embodiments, displaying the time, such as at block 706, may include displaying the time as a limited time display based, at least in part, on the single-word time stamp.

FIG. 7B is another flow chart illustrating a method for displaying time in a single-word UTC time stamp according to one embodiment of the disclosure. In comparison with the flow chart illustrated in FIG. 7A, the flow chart illustrated in FIG. 7B adds the decision step 703, which includes determining if the identifier bit, such as identifier bit 202 illustrated in FIG. 2, is set to ‘1’ or ‘0.’ As illustrated in the embodiment of FIG. 7B, the retrieving step of 702 is also modified. According to the embodiment of FIG. 7B, at block 702A, the single-word time stamp having a UTC time base may be retrieved. Subsequently, at block 703, a determination may be made as to whether or not the identifier bit of the retrieved single-word time stamp is set to ‘0’ or ‘1.’ When the identifier bit is determined to be set to ‘0’ then method 700B may proceed to block 708, wherein method 700B includes displaying time specified in the single-word time stamp as a limited time display. Alternatively, when the identifier bit is determined to be set to ‘1,’ then method 700B may proceed to block 702B, wherein the multi-word configuration key associated with the single-word time stamp is retrieved from memory. Although in the foregoing discussion, the identification bit being set to ‘0’ indicated a transition to block 708 whereas the identification bit being set to 1′ indicated a transition to block 702B, the specific value of indication bit may be reversed in other embodiments without departing from this disclosure in spirit or scope. For example, in another embodiment, the identification bit being set to ‘1’ may indicate a transition to block 708 whereas the identification bit being set to ‘0’ may indicate a transition to block 702B.

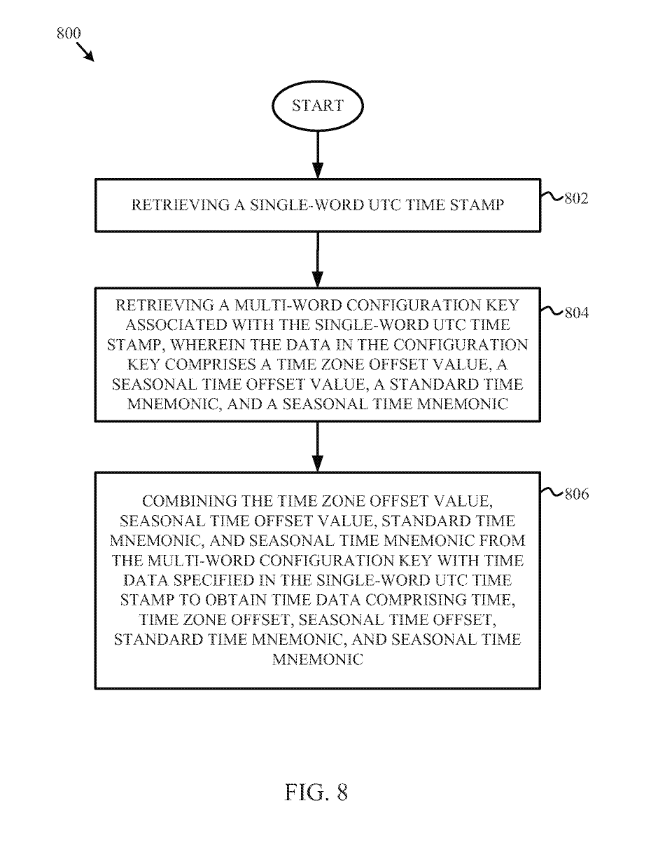

FIG. 8 is a flow chart illustrating a method for obtaining time data displayable remotely from a single-word UTC time stamp according to one embodiment of the disclosure, it is noted that embodiments of method 800 may be implemented with the systems described with respect to FIGS. 10-12. Specifically, method 800 includes, at block 802, retrieving a single-word UTC time stamp. At block 804, method 800 includes retrieving a multi-word configuration key associated with the single-word UTC time stamp, wherein the data in the configuration key comprises a time zone offset value, a seasonal time offset value, a standard time mnemonic, and a seasonal time mnemonic. At block 806, method 800 includes combining the time zone offset value, seasonal time offset value, standard time mnemonic, and seasonal time mnemonic from the multi-word configuration key with time data specified in the single-word UTC time stamp to obtain time data comprising time, time zone offset, seasonal time offset, standard time mnemonic, and seasonal time mnemonic.

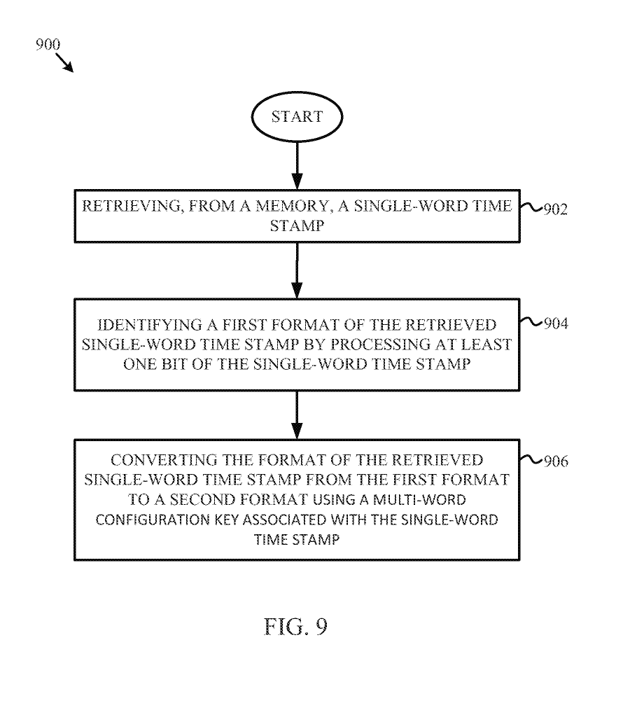

FIG. 9 is a flow chart illustrating a method for converting a format of a time stamp according to one embodiment of the disclosure. It is noted that embodiments of method 900 may he implemented with the systems described with respect to FIGS. 10-12. Specifically, method 900 includes, at block 902, retrieving, from a memory, a single-word time stamp. At block 904, method 900 includes identifying a first format of the retrieved single-word time stamp by processing at least one bit of the single-word time stamp. At block 906, method. 900 includes converting the format of the retrieved single-word time stamp from the first format to a second format using a multi-word configuration key associated with the single-word time stamp.

The schematic flow chart diagrams of FIGS. 1, 5, and 7-9 are generally set forth as logical flow chart diagrams. As such, the depicted order and labeled steps are indicative of aspects of the disclosed methods. Other steps and methods may be conceived that are equivalent in function, logic, or effect to one or more steps, or portions thereof, of the illustrated methods. Additionally, the format and symbols employed are provided to explain the logical steps of the methods and are understood not to limit the scope of the methods. Although various arrow types and line types may be employed in the flow chart diagrams, they are understood not to limit the scope of the corresponding methods. Indeed, some arrows or other connectors may be used to indicate only the logical flow of the methods. For instance, an arrow may indicate a waiting or monitoring period of unspecified duration between enumerated steps of the depicted methods. Additionally, the order in which a particular method occurs may or may not strictly adhere to the order of the corresponding steps shown,

FIG. 10 illustrates one embodiment of a system 1000 for implementing a multi-word UTC time stamp using a single-word UTC time stamp and a multi-word key, for distinguishing and processing multiple time stamp formats used in a single computing system, and for displaying time in a single-word UTC time stamp. The system 1000 may include a server 1002, a data storage device 1006, a network 1008, and a user interface device 1010. The server 1002 may also be a hypervisor-based system executing one or more guest partitions hosting operating systems with modules having server configuration information. In a further embodiment, the system 1000 may include a storage controller 1004, or a storage server configured to manage data communications between the data storage device 1006 and the server 1002 or other components in communication with the network 1008. In an alternative embodiment, the storage controller 1004 may be coupled to the network 1008.

In one embodiment, the user interface device 1010 is referred to broadly and is intended to encompass a suitable processor-based device such as a desktop computer, a laptop computer, a personal digital assistant (PDA) or tablet computer, a smartphone or other mobile communication device having access to the network 1008. In a further embodiment, the user interface device 1010 may access the Internet or other wide area or local area network to access a web application or web service hosted by the server 1002 and may provide a user interface for enabling a user to enter or receive information.

The network 1008 may facilitate communications of data between the server 1002 and the user interface device 1010. In some embodiments, the network 1002 may also facilitate communication of data between the server 1002 and other servers/processors, such as server 1002b. For example, the network 1008 may include a switched fabric computer network communications link to facilitate communication between servers/processors, also referred to as data storage nodes. In some embodiments, the servers 1002 and 1002b may represent nodes or clusters of nodes managed by a software framework. The network 1008 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

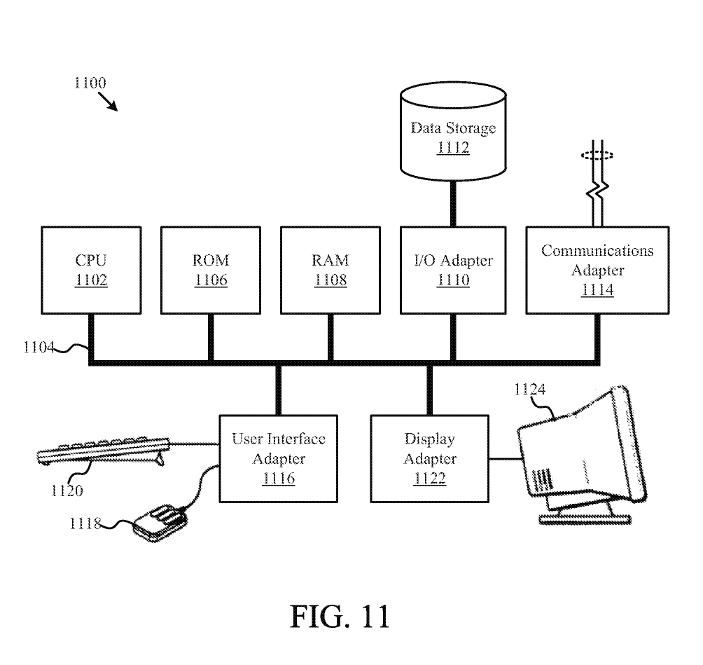

FIG. 11 illustrates a computer system 1100 adapted according to certain embodiments of the server 1002 and/or the user interface device 1010. The central processing unit (“CPU”) 1102 is coupled to the system bus 1104. The CPU 1102 may be a general purpose CPU or microprocessor, graphics processing unit (“GPU”), and/or microcontroller. The present embodiments are not restricted by the architecture of the CPU 1102 so tong as the CPU 1102, whether directly or indirectly, supports the operations as described herein. The CPU 1102 may execute the various logical instructions according to the present embodiments.

The computer system 1100 may also include random access memory (RAM) 1108, which may be synchronous RAM (SRAM), dynamic RAM (DRAM), synchronous dynamic RAM (SDRAM), or the like. The computer system 1100 may utilize RAM 1108 to store the various data structures used by a software application. The computer system 1100 may also include read only memory (ROM) 1106 which may be PROM, EPROM, EEPROM, optical storage, or the like. The ROM may store configuration information for booting the computer system 1100. The RAM 1108 and the ROM 1106 hold user and system data, and both the RAM 1108 and the RUM 1106 may be randomly accessed.

The computer system 1100 may also include an input/output (I/O) adapter 1110, a communications adapter 1114, a user interface adapter 1116, and a display adapter 1122. The I/O adapter 1110 and/or the user interface adapter 1116 may, in certain embodiments, enable a user to interact with the computer system 1100. In a further embodiment, the display adapter 1122 may display a graphical user interface (GUI) associated with a software or web-based application on a display device 1124, such as a monitor or touch screen.

The I/O adapter 1110 may couple one or more storage devices 1112, such as one or more of a hard drive, a solid state storage device, a flash drive, a compact disc (CD) drive, a floppy disk drive, and a tape drive, to the computer system 1100. According to one embodiment, the data storage 1112 may be a separate server coupled to the computer system 1100 through a network connection to the I/O adapter 1110. The communications adapter 1114 may be adapted to couple the computer system 1100 to the network 1008, which may be one or more of a LAN, WAN, and/or the Internet. The user interface adapter 1116 couples user input devices, such as a keyboard 1120, a pointing device 1118, and/or a touch screen (not shown) to the computer system 1100. The display adapter 1122 may be driven by the CPU 1102 to control the display on the display device 1124. Any of the devices 1102-1122 may be physical and/or logical.

The applications of the present disclosure are not limited to the architecture of computer system 1100. Rather the computer system 1100 is provided as an example of one type of computing device that may be adapted to perform the functions of the server 1002 and/or the user interface device 1110. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 1100 may be virtualized for access by multiple users and/or applications.

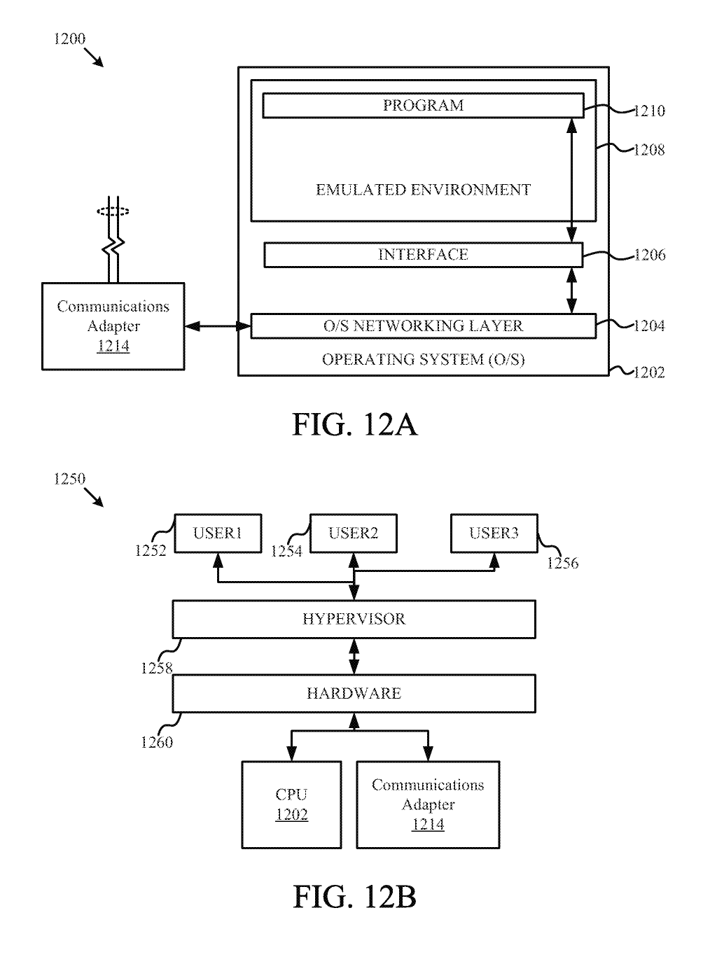

FIG. 12A is a block diagram illustrating a server hosting an emulated software environment for virtualization according to one embodiment of the disclosure. An operating system 1202 executing on a server includes drivers for accessing hardware components, such as a networking layer 1204 for accessing the communications adapter 1214. The operating system 1202 may be, for example Linux or Windows. An emulated environment 1208 in the operating system 1202 executes a program 1210, such as Communications Platform (CPComm) or Communications Platform for Open Systems (CPCommOS). The program 1210 accesses the networking layer 1204 of the operating system 1202 through a non-emulated interface 1206, such as extended network input output processor (XNIOP). The non-emulated interface 1206 translates requests from the program 1210 executing in the emulated environment 1208 for the networking layer 1204 of the operating system 1202.

In another example, hardware in a computer system may be virtualized through a hypervisor. FIG. 1213 is a block diagram illustrating a server hosting an emulated hardware environment according to one embodiment of the disclosure. Users 1252, 1254, 1256 may access the hardware 1260 through a hypervisor 1258. The hypervisor 1258 may be integrated with the hardware 1260 to provide virtualization of the hardware 1260 without an operating system, such as in the configuration illustrated in FIG. 12A. The hypervisor 1258 may provide access to the hardware 1260, including the CPU 1202 and the communications adaptor 1214.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs, Generally, disks reproduce data magnetically, and discs reproduce data optically. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data may be configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method for displaying time in a single-word coordinated universal time (UTC) time stamp, comprising:
retrieving, by a processor, from a memory, a single-word time stamp having a UTC time base and a multi-word configuration key associated with the single-word time stamp, wherein the single-word time stamp and the configuration key are associated with a data file;
processing, by the processor, the configuration key to obtain a time zone offset value, a seasonal time offset value, a standard time mnemonic, and a seasonal time mnemonic associated with the single-word time stamp; and
displaying, by the processor, time specified in the single-word time stamp as an fully qualified time based, at least in part, on the single-word time stamp and the obtained time zone offset value, seasonal time offset value, standard time mnemonic, and seasonal time mnemonic.

2. The method of claim 1, further comprising displaying the time as a limited time display based, at least in part, on the single-word time stamp.

3. The method of claim 1, further comprising determining a format of the single-word time stamp based, at least in part, on processing of at least one bit of the single-word time stamp that specifies a format of the single-word time stamp, wherein displaying the time as an fully qualified time is based on the determined format of the single-word time stamp.

4. The method of claim 1, wherein the memory from which the single-word time stamp and the configuration key are retrieved is located remotely.

5. A computer program product, comprising:
a non-transitory computer readable medium comprising instructions that, when executed by a processor of a computing system, cause the processor to perform the steps of:
retrieving, from a memory, a single-word time stamp having a UTC time base and a multi-word configuration key associated with the single-word time stamp, wherein the single-word time stamp and the configuration key are associated with a data file;
processing the configuration key to obtain a time zone offset value, a seasonal time offset value, a standard time mnemonic, and a seasonal time mnemonic associated with the single-word time stamp; and
displaying time specified in the single-word time stamp as an fully qualified time based, at least in part, on the single-word time stamp and the obtained time zone offset value, seasonal time offset value, standard time mnemonic, and seasonal time mnemonic.

6. The computer program product of claim 5, wherein the medium further comprises instructions that, when executed by a processor of a computing system, cause the processor to perform the step of displaying the time as a limited time display based, at least in part, on the single-word time stamp.

7. The computer program product of claim 5, wherein the medium further comprises instructions that, when executed by a processor of a computing system, cause the processor to perform the step of determining a format of the single-word time stamp based, at least in part, on processing of at least one bit of the single-word time stamp that specifies a format of the single-word time stamp, wherein displaying the time as an fully qualified time is based on the determined format of the single-word time stamp.

8. The computer program product of claim 5, wherein the memory from which the single-word time stamp and the configuration key are retrieved is located remotely.

9. An apparatus, comprising:
a memory;
a processor coupled to the memory, wherein the processor is further configured to perform the steps of:
retrieving, from a memory, a single-word time stamp having a UTC time base and a multi-word configuration key associated with the single-word time stamp, wherein the single-word time stamp and the configuration key are associated with a data file;
processing the configuration key to obtain a time zone offset value, a seasonal time offset value, a standard time mnemonic, and a seasonal time mnemonic associated with the single-word time stamp; and
displaying time specified in the single-word time stamp as an fully qualified time based, at least in part, on the single-word time stamp and the obtained time zone offset value, seasonal time offset value, standard time mnemonic, and seasonal time mnemonic.

10. The apparatus of claim 9, wherein the processor is further configured to perform the step of displaying the time as a limited time display based, at least in part, on the single-word time stamp.

11. The apparatus of claim 9, wherein the processor is further configured to perform the step of determining a format of the single-word time stamp based, at least in part, on processing of at least one bit of the single-word time stamp that specifies a format of the single-word time stamp, wherein displaying the time as an fully qualified time is based on the determined format of the single-word time stamp.

12. The apparatus of claim 9, wherein the memory from which the single-word time stamp and the configuration key are retrieved is located remotely.
